(19) United States
(12) Patent Application Publication
(10) Pub. No.: US 2021/0097307 A1
(43) Pub. Date: Apr. 1, 2021

(54) Optical Detection System

(71) Applicant: Conti Temic microelectronic GmbH, Nurnberg (DE)

(72) Inventor: Gunter Anton Fendt, Schrobenhausen (DE)

(73) Assignee: Conti Temic microelectronic GmbH, Nurnberg (DE)

(21) Appl. No.: 17/101,487

(22) Filed: Nov. 23, 2020

Related U.S. Application Data
(63) Continuation of application No. PCT/DE2019/200042, filed on May 15, 2019.

(30) Foreign Application Priority Data
May 24, 2018 (DE) 10 2018 208 136.0

(51) Int. Cl. G06K 9/00; H04N 7/18; G06K 9/20

(52) U.S. Cl. CPC G06K 9/00791; B60R 11/04; G06K 9/209; H04N 7/18

(57) ABSTRACT

An optical detection system for a vehicle having a detection region for recording a section of the surroundings. The optical detection system has an image receiver chip having a maximum number of pixels. During the recording of an image of the surroundings a number of pixels is active in a pixel region to be evaluated of the image receiver chip. The maximum number of pixels of the image receiver chip is greater than the number of pixels of the pixel region to be evaluated. The optical detection system detects a region lying behind the vehicle and is designed such that, if the tailgate is moved, the detection region remains substantially unchanged as a result of a change to the pixel region to be evaluated on the image receiver chip. A method for retaining a detection region of an optical detection system is also disclosed.

### CROSS-REFERENCE TO RELATED APPLICATIONS

This application claims the benefit of International Application PCT/DE2019/200042, filed May 15, 2019, which claims priority to German Application DE 10 2018 208 136.0, filed May 24, 2018. The disclosures of the above applications are incorporated herein by reference.

### TECHNICAL FIELD

The disclosure relates to an optical detection system having a detection region as well as a method for retaining the detection region.

### BACKGROUND

Optical systems for detecting the surroundings around a vehicle have now become the prior art in the vehicle world.

During the image processing of the recorded data or the data fusion, a very high computational power is in general required. Admittedly, restricting the computational power of a microprocessor leads to the problem that the information to be processed is in principle subject to a restriction. A restriction can, for example, be realized by limiting the repetition rate of the processing cycles within a predefined period of time.

The disadvantage of the prior art is that the cameras have image receiver chips with fixed recording regions, as a result of which the detection region of the camera depends on the location or alignment of the camera. If the camera experiences an alteration in its location, then its detection region also automatically alters, as a result of which potentially critical obstacles are no longer displayed, although they are still present. This can lead to a reduction in driving safety.

### SUMMARY

The disclosure provides an optical detection system that improves detection of a section of the surroundings and increases traffic safety, where the computational power required for evaluation remains constant.

An optical detection system for a vehicle having a detection region for recording a section of the surroundings is provided. The optical detection system has an image receiver chip. The image receiver chip has a maximum number of pixels. During the recording of an image of the surroundings a number of pixels is active in a pixel region to be evaluated of the image receiver chip. The maximum number of pixels of the image receiver chip is greater than the number of pixels of the pixel region to be evaluated. The optical detection system detects a region lying behind the vehicle and is designed such that, if the tailgate is moved, the detection region remains substantially unchanged as a result of a change to the pixel region to be evaluated on the image receiver chip.

Implementations of the disclosure may include one or more of the following optional features. In some implementations, the detection region remains uniform or the same, even if the detection system experiences an alteration in its location. As a result, the same surrounding region can be recorded, irrespective of the location or position of the detection system. This is in particular advantageous if the detection system or a camera of the detection system is arranged on a tailgate of a vehicle. If bulky goods are now transported with the vehicle so that the tailgate cannot be closed completely, then the surrounding region which corresponds to that surrounding region which would be recorded by a camera arranged on a closed tailgate can nevertheless be recorded.

The disclosure provides a compensation effect; an unwanted displacement of the detection region may be prevented to the greatest possible extent by the latter. This is achieved due to the dependence between the movement of the tailgate and the change of the pixel region to be evaluated.

In order to successfully retain the detection region, the image receiver chip has a larger total number of pixels than are active for detecting the image of the surroundings, and the pixel region to be evaluated can be changed. The pixel region to be evaluated describes the region of the image receiver chip in which the active pixels lie. Consequently, this is a pixel region to be evaluated or an active pixel region. An active pixel region is understood to be one pixel region or multiple pixel regions which is/are evaluated during the further course of the process.

In some implementations, a movement of a tailgate is understood to be a tilting of the tailgate, for example, an opening and/or closing of the tailgate.

The optical detection system or elements of the optical detection system can be arranged on at least one outer side of the vehicle. The optical detection system or individual elements of the optical detection system may be arranged on a tailgate. In some examples, the optical detection system includes a camera arranged on a tailgate of the vehicle. The camera may be a mono camera or a stereo camera. The camera of a surround-view system would also be conceivable.

The opening angle of the tailgate may be determined by an angle measuring sensor. In some examples, the detection system has at least one angle measuring sensor, for example, a magnetic field sensor such as, for example a magnetometer or a Hall sensor, or a potentiometer.

In some implementations, the number of pixels of the pixel region to be evaluated and/or the size of the pixel region to be evaluated remain(s) constant, if the pixel region to be evaluated is displaced or altered. This leads to the resolution remaining constant if the pixel region to be evaluated is altered. In this way, the active pixel region is prevented from simply being extended which, if the resolution were to remain uniform, would require an increased computational power. In this case, the required computational power is accordingly kept constant in an advantageous manner.

In some examples, the opening angle of the tailgate changes, the pixel region to be evaluated remains unchanged in the horizontal direction.

The pixel region to be evaluated changes in the vertical direction as the opening angle of the tailgate changes. For example, the pixel region to be evaluated is displaced upwards on the receiver chip, if the opening angle enlarges. For example, the pixel region to be evaluated is displaced downwards on the receiver chip, if the opening angle decreases. As a result, a compensation effect is attained so that the detection region remains unchanged to the greatest possible extent and is not displaced as well, as is usual, during the movement of the tailgate.

The recorded section of the surroundings may be provided to a driver assistance system and/or to a driver. The section of the surroundings may be provided to the driver by one or more display devices. The optical detection system advantageously has at least one display device. In some examples, the display device depicts the recorded section of the surroundings. The display device may display the pixel region to be evaluated, for example, exclusively the pixel region to be evaluated. In some examples, the pixel region to be evaluated is displayed as a full screen.

Furthermore, a method for retaining a detection region of an optical detection system is proposed according to the disclosure. The method includes the following steps: detecting a section of the surroundings; determining an opening angle of a tailgate of a vehicle; and changing the pixel region to be evaluated on the image receiver chip as a function of the opening angle of the tailgate, as a result of which the detection region of the optical detection system remains largely the same.

Despite an alteration in the opening angle of the tailgate, which is produced by a tilting of the tailgate, the method provides that the detection region of the detection system remains unchanged.

The opening angle of the tailgate may be determined by at least one angle measuring sensor. The angle measuring sensor may be a magnetic field sensor or a potentiometer.

In some examples of the method, in the event of a change to the active pixel region to be evaluated, the number of pixels and/or the size of the active pixel region to be evaluated remain(s) constant. As already mentioned, a constant computational power is also attained due to the constant number of pixels.

The pixel region to be evaluated on the image receiver chip may be displaced in the vertical direction as the opening angle of the tailgate is altered. For example, the pixel region to be evaluated on the image receiver chip is displaced upwards as the opening angle of the tailgate becomes larger. If the opening angle of the tailgate is reduced, the pixel region to be evaluated on the image receiver chip is then displaced downwards. However, it is advantageous if the pixel region to be evaluated remains unchanged in the horizontal direction.

The detected section of the surroundings may be provided to a driver assistance system and/or a driver. The section of the surroundings may be provided to the driver via one or more display devices. For example, only the pixel region to be evaluated is displayed on the display device, ideally as a full screen.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1a shows a vehicle having an optical detection system in accordance with the prior art.

FIG. 1b shows a vehicle having an optical detection system in accordance with the prior art.

FIG. 2a shows a schematic depiction of a vehicle with an exemplary optical detection system.

FIG. 2b shows a schematic depiction of a vehicle with an exemplary optical detection system.

FIG. 3a shows an exemplary image receiver chip having an active pixel region as well as a display device.

FIG. 3b shows the image receiver chip from FIG. 3a having a changed, active pixel region as well as a display device.

FIG. 4 show a schematic flow chart of the exemplary method of retaining a detection region of an optical detection system.

Like reference symbols in the various drawings indicate like elements.

### DETAILED DESCRIPTION

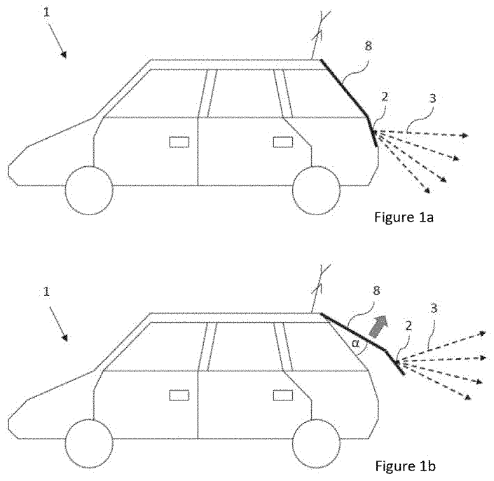

FIGS. 1a and 1b show a vehicle 1 having an optical detection system 2 in accordance with the prior art. The optical detection system 2 is arranged on a tailgate 8 of a vehicle 1 and has a detection region 3 which includes a region behind the vehicle 1.

Whilst the tailgate 8 of the vehicle 1 is located in a closed condition in FIG. 1a, the tailgate 8 in FIG. 1b has been opened or tilted by an angle α. In this case, it can be seen that the detection region 3 of the optical detection system 2 has changed as a result of the opening of the tailgate 8. The section of the surroundings recorded in FIG. 1b by the optical detection system 2 lies above the section of the surroundings which has been recorded in FIG. 1a. This is in particular due to the fact that the optical detection system 2 is fixedly arranged on the tailgate 8 and, consequently, the detection region 3 also moves upwards with the tailgate 8. As a result, the surroundings located immediately behind the vehicle 1 are not detected. The region which is detected by the detection system 2 according to the prior art therefore depends on the position of the tailgate. This is in particular disadvantageous if bulky goods 9 are being transported with the vehicle 1 and the tailgate cannot be closed completely due to the bulky goods. Consequently, the detection system 2 has a detection region 3 which is displaced upwards in an unwanted manner. As a result, it can happen that the region located immediately behind the vehicle 1 is no longer detected, as a result of which obstacles are not identified, and this can lead to unwanted collisions. The driving safety is considerably diminished as a result. According to the disclosure, it is important to largely compensate for this indicated unwanted displacement of the detection region.

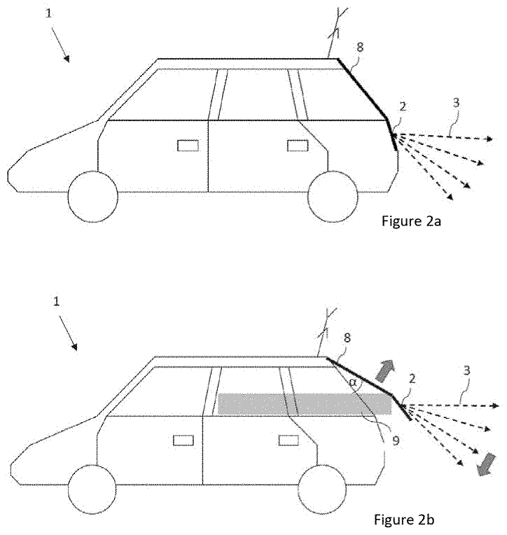

FIGS. 2a and 2b show a schematic depiction of a vehicle 1 having an optical detection system 2 according to the disclosure having a detection region 3 for recording a section of the surroundings is depicted. The detection system 2 includes an image receiver chip 4 having a maximum number of pixels, composed of active pixels 7 and inactive pixels 5. The active pixels 7 form a pixel region 6 to be evaluated. The pixel region 6 to be evaluated only constitutes a subregion of the image receiver chip 4.

The detection system 2 is arranged on a tailgate 8 of the vehicle 1. Whilst the tailgate 8 is closed in FIG. 2a, bulky goods 9 are located in the vehicle 1 depicted in FIG. 2b so that the tailgate 8 cannot be closed. The tailgate 8 is opened by an opening angle α. The opening angle α can be determined by an angle measuring sensor, such as a magnetic field sensor or a potentiometer. To this end, the detection system 2 has at least one angle measuring sensor.

As depicted in FIGS. 2a and 2b, the detection region 3 of the detection system 2 is the same, although the tailgate 8 is in a closed condition in FIG. 2a and in an open position in FIG. 2b, that is to say it is tilted by an opening angle α. This is achieved according to the disclosure in that the pixel region 6 to be evaluated on the image receiver chip 4 can be changed as a function of the opening angle α. If the tailgate 8 is, for example, tilted upwards, that is to say brought into an open position, then the pixel region 6 to be evaluated on the image receiver chip 4 is displaced upwards. If the tailgate 8 is closed, then the pixel region 6 to be evaluated on the image receiver chip 4 is displaced downwards.

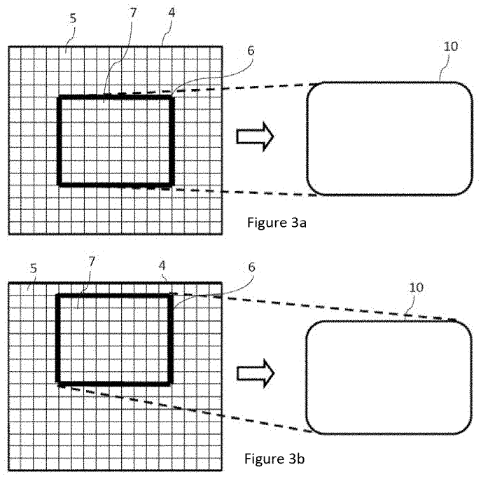

FIG. 3a shows an image receiver chip 4 according to the disclosure having a maximum number of pixels, composed of active pixels 7 and inactive pixels 5, and a pixel region 6 to be evaluated. The pixel region 6 only constitutes a subregion of the image receiver chip 4 and has the active pixels 7, that is to say those pixels which are actively evaluated. The image receiver chip 4 depicted in FIG. 3a is part of the detection system 2 depicted in FIG. 2a, as a result of which the detection region 3 depicted in FIG. 2a is detected.

FIG. 3b shows the image receiver chip 4 according to the disclosure from FIG. 3a, where the active pixel region 6 has been changed. The image receiver chip 4 depicted in FIG. 3a is part of the detection system 2 depicted in FIG. 2b, as a result of which the detection region 3 depicted in FIG. 2b is detected.

Compared to the active pixel region 6 shown in FIG. 3a, the active pixel region 6 shown in FIG. 3b is displaced upwards. The size of the pixel region 6 to be evaluated and/or the number of the active pixels 7, in this case, correspond(s) to those in FIG. 3a. No alteration has taken place in the horizontal direction. In particular, the change to the active pixel region 6 ensures that, in the event of a tilting of the tailgate 8, the detection region 3 remains largely unchanged. Despite a movement of the tailgate 8, the same surrounding region is detected.

A display device 10 is further depicted in FIGS. 3a and 3b. In some implementations, the display device 10 only displays the pixel region 6 to be evaluated, for example, as a full screen.

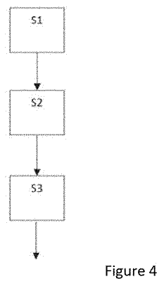

FIG. 4 shows a schematic flow chart of the method according to the invention. In step S1, a section of the surroundings is detected. In step S2, the opening angle α of the tailgate 8 of the vehicle is determined. The opening angle α can be determined by at least one angle measuring sensor, for example a magnetic field sensor and/or a potentiometer. In step S3, if necessary, the pixel region 6 to be evaluated on the image receiver chip 4 is changed as a function of the opening angle α of the tailgate 8, as a result of which the detection region 3 does not substantially change, that is to say it remains largely the same. That is to say that the method ensures that, despite an alteration to the opening angle α of the tailgate 8, for example due to a tilting of the tailgate 8, the detection region 3 of the detection system 2 does not alter. Consequently, this results in the attainment of a compensation effect so that the detection region 3 of the detection system 2 is not displaced as well—as is usual—during the movement of the tailgate. The detection region 3 continues to show the region lying behind the vehicle 1 as it did prior to the tilting of the tailgate 8.

The pixel region 6 to be evaluated on the image receiver chip 4 is displaced upwards as the opening angle α becomes larger. The number of the active pixels 7 or the size of the pixel region 6 to be evaluated ideally remain(s) the same or unchanged. Ideally, the pixel region 6 to be evaluated does not experience any alteration in the horizontal direction. It remains the same. In some implementations, the recorded section of the surroundings is provided to a driver on a display device 10. The pixel region 6 to be evaluated or the data of the pixel region 6 to be evaluated may be displayed as a full screen.

A number of implementations have been described. Nevertheless, it will be understood that various modifications may be made without departing from the spirit and scope of the disclosure. Accordingly, other implementations are within the scope of the following claims.

What is claimed is:

1. An optical detection system for a vehicle, the optical detection system comprising:
a detection region for recording a section of the surroundings;
an image receiver chip having a maximum number of pixels,
wherein during a recording of an image of the surroundings a number of pixels is active in a pixel region to be evaluated of the image receiver chip,
wherein the maximum number of pixels of the image receiver chip is greater than the number of pixels of the pixel region to be evaluated, wherein the optical detection system detects a region lying behind the vehicle and when a tailgate of the vehicle is moved, the detection region remains substantially unchanged as a result of a change to the pixel region to be evaluated on the image receiver chip.

2. The optical detection system according to claim 1, wherein the optical detection system comprises a camera arranged on the tailgate of the vehicle.

3. The optical detection system according to claim 1, further comprising at least one angle measuring sensor which measures an opening angle of the tailgate.

4. The optical detection system according to claim 1, wherein the number of pixels of the pixel region to be evaluated and/or the size of the pixel region to be evaluated is/are constant.

5. The optical detection system according to claim 1, wherein as an opening angle of the tailgate changes, the pixel region to be evaluated remains unchanged in a horizontal direction.

6. The optical detection system according to claim 1, wherein as an opening angle of the tailgate changes, the pixel region to be evaluated changes in a vertical direction.

7. The optical detection system according to claim 1, further comprising a display device which displays the pixel region to be evaluated.

8. The optical detection system according to claim 7, wherein the display device displays the pixel region to be evaluated, as a full screen.

9. A method for retaining a detection region of an optical detection system, the method comprising:
detecting a section of the surroundings;
determining an opening angle of a tailgate of a vehicle;
changing a pixel region to be evaluated on an image receiver chip as a function of the opening angle of the tailgate, as a result of which the detection region of the optical detection system remains largely the same.

10. The method according to claim 9, wherein the opening angle of the tailgate is determined by at least one angle measuring sensor.

11. The method according to claim 10, wherein the at least one angle measuring sensor includes a magnetic field sensor and/or a potentiometer.

12. The method according to claim 9, wherein the pixel region to be evaluated on the image receiver chip is displaced upwards as the opening angle becomes larger.
